(19) United States
(12) Patent Application Publication
(10) Pub. No.: US 2005/0067541 A1
(43) Pub. Date: Mar. 31, 2005

(54) Flexible conduit support

(76) Inventors: Cong Dinh, Collierville, TN (US); Ian Rubin de la Borbolla, Memphis, TN (US)

Correspondence Address: Michael L. Hoelter;Thomas & Betts Corporation, 8155 T&B Boulevard, 4B-36, Memphis, TN, 38125, US

(21) Appl. No.: 10/935,417

(22) Filed: Sep. 7, 2004

Related U.S. Application Data
(60) Provisional application No. 60/507,025, filed on Sep. 29, 2003.

(51) Int. Cl. F16L 3/08

(52) U.S. Cl. 248/200

(57) ABSTRACT

A support for flexible conduit extending within the wall cavity of a building. The support consists of a bracket and flange supported by a wall support with at least the flange portion thereof extending into the wall cavity. The flange is configured with a series of cut-outs therein that are sized to partially surround a spiral recessed portion of a flexible conduit found in the wall cavity. The adjacent spiral raised portion of the flexible conduit engages the flange and is supported therefrom. These cut-outs may be of different sizes so as to accommodate differently sized flexible conduit therein.

### FIELD OF THE INVENTION

This invention pertains to a bracket for mounting electrical boxes within the walls of a building and more particularly to a bracket that also supports one or more runs of flexible conduit that supply wires to the electrical box.

### BACKGROUND OF THE INVENTION

As is well known, wires running to electrical outlet boxes are enclosed within electrical conduit for safety reasons. In some rare instances, the mounting brackets employed to secure the box to the wall support (whether it be wood, steel or otherwise) also include means for additionally supporting the conduit extending to the box.

One example of such a bracket is shown in U.S. Pat. No. 6,590,155 to Vrame et al. This technology requires the conduit holding tab to be bent or moved out of the way in order to install the conduit within the bracket. Likewise, the tab must be bent out of the way if the conduit is to be removed from the bracket once installed therein—which is likely to occur when the installer needs to re-position the conduit so that it can be properly terminated at the box.

Another such bracket is shown in U.S. Patent Application Publication No. 2003/0182881 to Denier et al. which was filed on Mar. 28, 2002 under application Ser. No. 10/108,307. This bracket employs a pair of bendable tabs that must be deflected for conduit insertion and which must also be bent out of the way for conduit removal in the event the conduit needs to be re-positioned as described above.

While these features are desirable, each of the above are also lacking in some fashion. For example, they both require one or more tabs to be bent thus meaning that the material must be thin and flexible enough to permit such bending to occur. This flexibility requirement reduces the ability of these brackets to also solidly support the conduit within the wall cavity. Furthermore, the need to bend and possibly re-bend tabs prolongs conduit installation and obligates the installer to complete more tasks in the field thereby complicating such installations. Also, the tabs, if bent too frequently or too much, can break which would then render this feature useless.

It is thus an object of the present invention to provide a bracket for mounting electrical boxes within the walls of a building that overcomes these deficiencies. One object of this invention is to provide a means of supporting conduit adjacent the box without the need to bend tabs or require additional field operations by the installer. Another object of this invention is to provide a way of enabling the installer to insert, remove, and re-insert or re-position the conduit as needed in an efficient manner without the need for secondary operations. Yet another object of this invention is to provide such a feature in a manner that can be easily manufactured in order to keep costs to a minimum. These and other objects and advantages of this invention will become obvious upon further investigation.

### SUMMARY OF THE INVENTION

This invention pertains to a support for flexible conduit running within a wall of a building. The bracket is configured to be mounted to at least one wall support of the building and is designed to incorporate a flange that extends into the wall cavity itself. The flange has at least one cut-out therein that is sized to partially surround a spiral recessed portion of a flexible conduit so that an adjacent spiral raised portion of the flexible conduit engages the flange and is supported therefrom.

### BRIEF DESCRIPTION OF THE DRAWINGS

FIG. 1 is a pictorial view of the invention shown installed to the wall studs and floor track of a building under construction.

FIG. 2 is a pictorial front view of the invention in its pre-installed state.

FIG. 3 is a pictorial back view of the invention in its pre-installed state.

FIG. 4 is an enlarged pictorial view of the conduit support portion of the bracket shown in FIGS. 1-3.

FIGS. 5-7 are various embodiments of the conduit support portion of the bracket shown in FIG. 4

### DETAILED DESCRIPTION OF THE PREFERRED EMBODIMENT

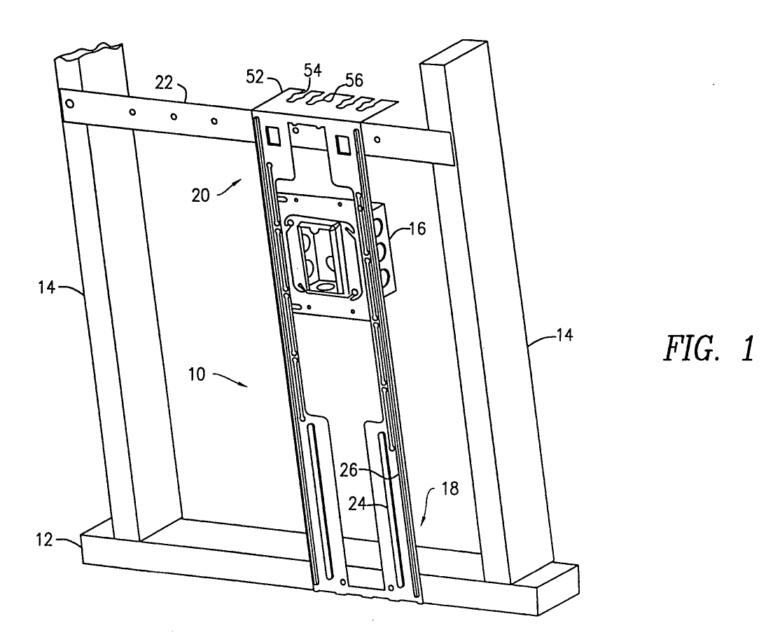

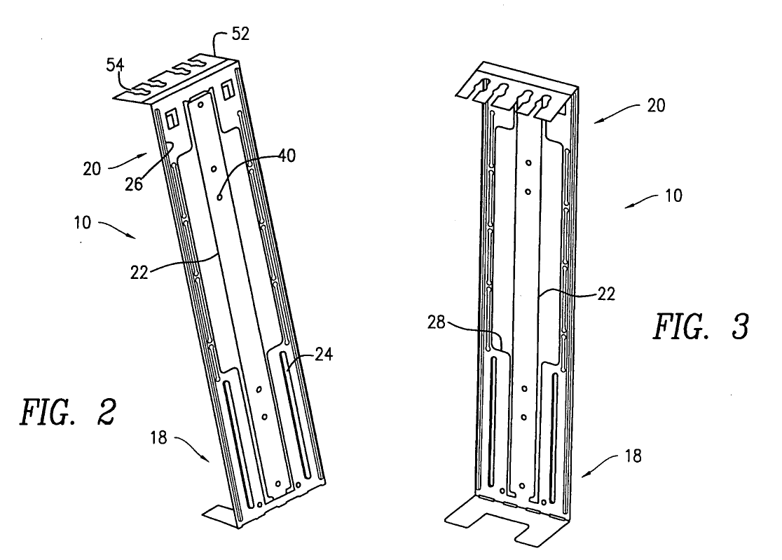

Referring initially to FIGS. 1-3, there is shown in this embodiment bracket 10 extending vertically from floor track 12 between adjacent wall studs 14 of a building. Bracket 10 is elongated in shape and may be constructed from thin metal material, but other materials are equally suitable, bracket 10 also need not be unitary as illustrated. Bracket 10 is designed to mount an electrical box 16 a desired distance above the floor of the building within a wall cavity between adjacent studs 14. A lower portion 18 of bracket 10 can be directly mounted to floor track 12 such as via screws or nails or by being inserted between floor track 12 and the floor. Upper portion 20 of bracket 10 is supported by bar 22 that spans between studs 14. Bar 22 prevents upper portion 20 of bracket 10 from deflecting into or away from (i.e. in either direction) with respect to the wall cavity. Ribs and/or stiffeners 24 and 26 extend along the length of bracket 10 as needed to also provide stiffness or rigidity.

The embodiment shown discloses bracket 10 supported vertically via floor track 12 and wall studs 14, but it is also conceivable that bracket 10 will be supported solely by floor track 12 or solely by one or more studs 14, or even from or in conjunction with a ceiling support if such is desired by the installer. Furthermore, bracket 10 need not be limited solely to vertically extending brackets as it can just as easily extend horizontally. It is only required that bracket 10 be mounted to a wall support or wall structure of some kind, whether such wall support/structure be the floor track 12, stud 14, ceiling support, corner support, brace or other supporting structure typically found or employed in a building.

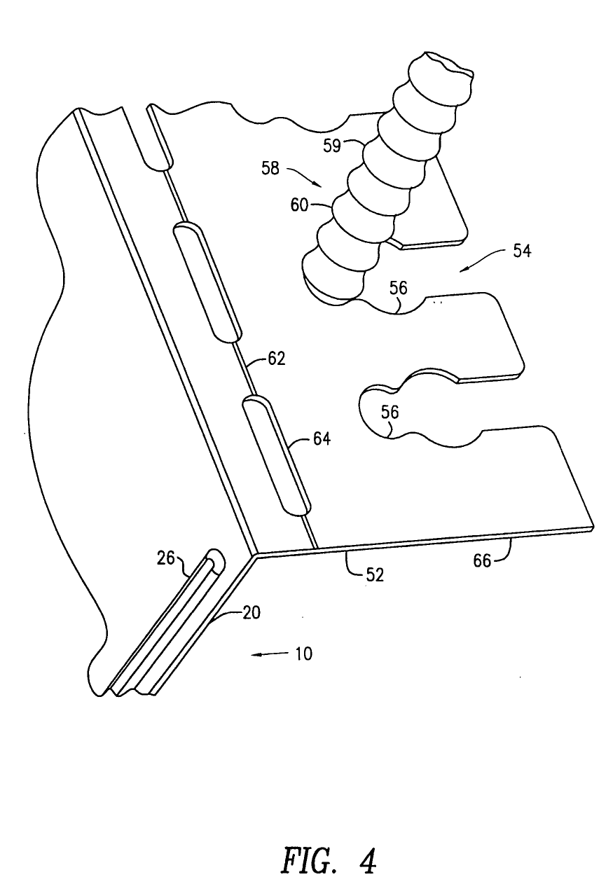

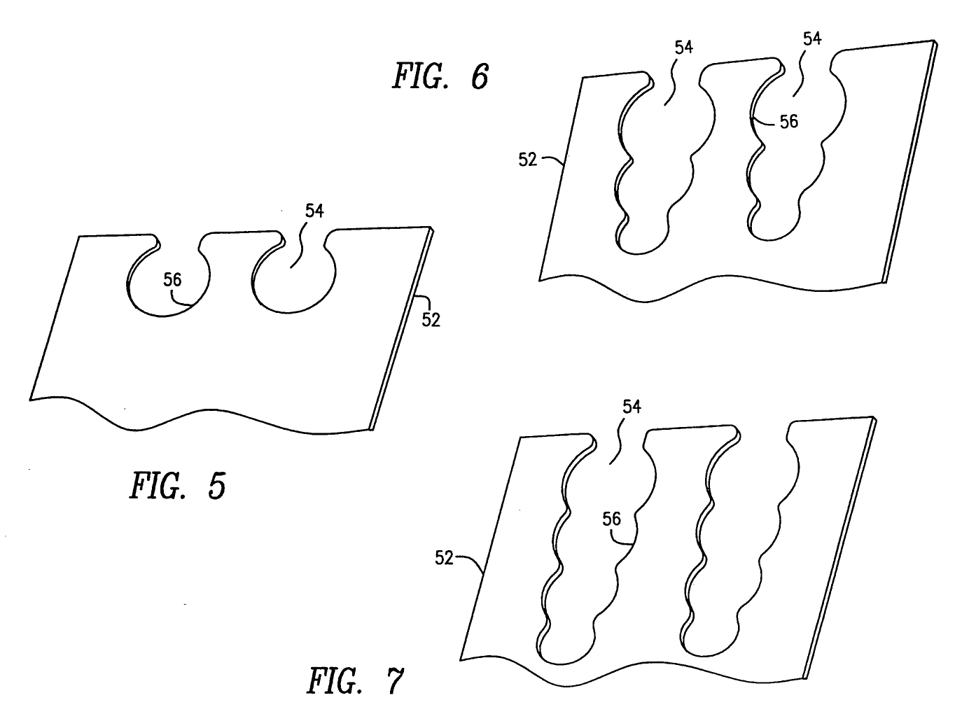

Referring now to FIGS. 4-7, upper portion 20 of bracket 10 incorporates an upper flange 52 having at least one opening 54 formed therein (the embodiments shown disclose a plurality of such openings 54). Each of the embodiments of FIGS. 4-7 disclose identical openings 54 extending along flange 52 but it is conceivable that flange 52 in each such embodiment may contain different or non-identical openings 54 as well. The obvious differences in the embodiments of FIGS. 4-7 are in the number and size of cut-outs 56 comprising each such opening 54. FIG. 5 discloses opening 54 with a single cut-out 56 while the other figures disclose openings 54 having multiple (and differently sized) cut-outs 56 therein. Each cut-out 56 is sized to be smaller than the outermost or external circumference of the spiral raised rib portion 59 of flexible conduit 58 which cut-out 56 is intended to support. In other words, the radius of each cut-out 56 is sized smaller than the radius of the outermost external perimeter of the spiral raised rib portion 59 of flexible conduit 58 which cut-out 56 is intended to support. Hence, different sized cut-outs 56 support different sized flexible conduits 58. Also, an opening 54 with multiple cut-outs 56 can support multiple flexible conduits 58 therein, there is no need to limit each opening 54 to supporting only a single flexible conduit 58. Thus, since the cut-outs 56 in an opening 54 may all be the same (or they may all be different), an opening 54 is capable of supporting a plurality of similarly sized flexible conduit 58 (or a plurality of differently sized flexible conduit 58) therein. It also goes without saying that an opening 54 may contain both similarly sized and differently sized cut-outs 56 therein. Any combination of quantity (i.e. number) and size of cut-outs 56 in each opening 54 are possible.

Referring now more specifically to FIG. 4, a typical flexible conduit 58 is shown which is externally configured with a spiral depression or recessed portion 60 between adjacent raised portions 59. Recessed portion 60 of flexible conduit 58 is equal in size or smaller than cut-out 56 such that recessed portion 60 fits into cut-out 56 which causes adjacent raised (and larger) portion 59 to come to rest against that region of flange 52 surrounding cut-out 56. Hence, by this arrangement, conduit 58 is supported from flange 52. In some circumstances, the installer may need to angle conduit 58 to fit recessed portion 60 within cut-out 56 if he/she cannot insert conduit 58 directly into cut-out 56 from a vertical orientation. No bending of flange 52 is required to retain conduit 58 in place nor is any bending of flange 52 required to remove such conduit. However, it is not out of the realm of possibilities that an installer may still crimp flange 52 or otherwise modify the installation instructions simply to be further assured that conduit 58 is and remains supported from bracket 10. Flange 52 can accommodate this need for possible further assurance. It should also be noted that in the embodiment shown, flexible conduit 58 is shown as extending vertically within the wall cavity with each cut-out 56 being in a horizontal plane. However, this need not always be the case as flange 52 can also be adjusted or arranged so as to support a flexible conduit 58 that is angled or non-vertical within the wall cavity.

FIG. 4 also shows in greater detail score line 62 interrupted in its journey along flange 52 by spaced slots 64. Of course, slots 64 can be eliminated altogether leaving only score line 62, but this would make it harder to separate extending region 66 of flange 52 from bracket 10 (this extending region 66 being that portion of flange 52 adjacent openings 54). In some circumstances, it may be desirable to remove all or part of this extending region 66 if it interferes with other items in the wall cavity or if it hampers the installer's ability to reach and/or work on box 16. Should this be the case, then the installer need only remove this extending region 66 (or portion thereof) by flexing it up and down till it breaks along score line 62. Obviously, slots 64 are spaced so that openings 54 which contain flexible conduit 58 therein may remain attached to bracket 10 while un-used openings 54 can be disabled or removed as needed.

It should also be understood that this conduit support feature incorporating openings 54 and cut-outs 56 are equally suitable for use with wall-mounted box brackets that extend horizontally between studs 14 (not shown). In this version, extending region 66 would still extend into the wall cavity and all or portions of it could still be removed in the manner described should such be desired by the installer, but at the same time, the option is available in the event the installer desires to support conduit 58 therefrom. While it is anticipated that openings 54 and cut-outs 56 would extend along the length of this bracket spanning adjacent studs, it is also conceivable that only a portion of this bracket would incorporate such features.

While select preferred embodiments of this invention have been illustrated, many modifications may occur to those skilled in the art and therefore it is to be understood that these modifications are incorporated within these embodiments as fully as if they were fully illustrated and described herein.

1. A support for flexible conduit located within a wall cavity of a building comprising:
(a) a bracket configured to be mounted to at least one wall support;
(b) a flange supported by said bracket and positioned within the wall cavity;
(c) said flange having at least one cut-out therein sized smaller than the outermost spiral raised portion of the flexible conduit whereby an interior region of the flexible conduit engages said flange and is supported therefrom.

2. A support for flexible conduit located within a wall cavity of a building comprising:
(a) a bracket configured to be mounted to at least one wall support;
(b) a flange supported by said bracket and positioned within the wall cavity;
(c) said flange having at least one cut-out therein the radius of which is smaller than the radius of the outermost external surface of the spiral raised portion of the flexible conduit said flange is intended to support.

3. A support for flexible conduit located within a wall cavity of a building comprising:
(a) a bracket configured to be mounted to at least one wall support;
(b) a flange supported by said bracket and positioned within the wall cavity;
(c) said flange having a plurality of openings therein with each said opening containing a cut-out sized to support a flexible conduit therein, wherein a said cut-out of one said opening is sized differently from a said cut-out of another said opening, said differently sized cut-outs supporting differently sized flexible conduit therein.

4. A support for flexible conduit located within a wall cavity of a building comprising:
(a) a bracket configured to be mounted to at least one wall support;
(b) a flange supported by said bracket and positioned within the wall cavity;
(c) said flange having at least one opening therein containing a plurality of cut-outs, each said cut-out sized to support a flexible conduit therein.

5. The support of claim 4 wherein said cut-outs are differently sized in order to support differently sized flexible conduit therein.

6. A bracket for supporting flexible conduit within a wall cavity comprising:
(a) a first portion configured for securement to at least one wall support;
(b) a second portion extending from said first portion and located in the wall cavity;
(c) said second portion having at least one opening therein configured with at least one cut-out sized to receive a spiral recessed portion of a flexible conduit whereby said cut-out is sized equal to or greater than the external dimension of said spiral recessed portion but smaller than the external dimension of the adjacent spiral raised portion of the flexible conduit.

7. The bracket of claim 6 wherein said second portion is configured with differently sized cut-outs to accept differently sized flexible conduit therein.

8. The bracket of claim 6 wherein said second portion is configured with at least one opening containing a plurality of cut-outs therein.

9. The bracket of claim 8 wherein said cut-outs are differently sized in order to support differently sized flexible conduit therein.

10. A method of supporting a flexible conduit within a wall cavity bounded by wall supports comprising the steps of:
(a) affixing a bracket to one or more wall supports;
(b) positioning at least a portion of said bracket in the wall cavity, said bracket portion configured with at least one opening therein sized to partially surround a spiral recessed region of the flexible conduit; and,
(c) maneuvering the flexible conduit to fit within said opening so that a spiral raised region of the flexible conduit is supported by said bracket portion.

11. The method of claim 10 further comprising the step of configuring said bracket portion with differently sized openings to accept differently sized flexible conduit therein.

12. The method of claim 10 further comprising the step of configuring said bracket portion with at least one opening containing a plurality of cut-outs, each said cut-out sized to support a flexible conduit therein.

13. The method of claim 12 further comprising the step of configuring said cut-outs of different sizes in order to support differently sized flexible conduit therein.
